(19) United States
(12) Patent Application Publication
(10) Pub. No.: US 2022/0128063 A1
(43) Pub. Date: Apr. 28, 2022

(54) DUAL BLADE BLOWER

(71) Applicant: Young Hwan SHIN, Uijeongbu-si Gyeonggi-do (KR)

(72) Inventor: Young Hwan SHIN, Uijeongbu-si Gyeonggi-do (KR)

(21) Appl. No.: 17/422,751

(22) PCT Filed: Apr. 28, 2020
(86) PCT No.: PCT/KR2020/005606

§ 371 Date: Jul. 14, 2021

(30) Foreign Application Priority Data
Aug. 12, 2019 (KR) 10-2019-0097916

(51) Int. Cl. F04D 29/32; F04D 29/34; F04D 29/64; F04D 19/00

(52) U.S. Cl. CPC F04D 29/325; F04D 29/34; F04D 29/056; F04D 19/007; F04D 29/646

(57) ABSTRACT

The present invention relates to a dual blade blower. A dual blade blower according to an embodiment of the present invention comprises a first blade part having a first body formed in an open cylinder shape, and having a plurality of first blades formed on the outer side thereof. The blower further comprises a second blade part having a second body, which is formed in an open cylinder shape so as to be inserted into the first body and be freely rotatable, and having a plurality of second blades formed on the inner side thereof. The blower further comprises a bearing which is formed in a circular ring shape so as to be inserted into the first body, and into which the second blade part is inserted. Therefore, various flows of fluid can be generated according to the independent rotation of the plurality of blades.

### TECHNICAL FIELD

The present invention relates to a dual blade blower, and more particularly, to a technology for generating various flows of fluid by rotating two blades in different rotational directions.

### BACKGROUND ART

An electric fan is used to cool the heat by using the wind produced by rotation of a blower fan. In a general fan structure, when a user selectively operates an operation button provided on a main body, a motor turns clockwise, and a blower fan coupled to a rotation shaft of the motor rotates clockwise. In this case, the blower fan of the conventional electric fan has a structure in which a rotating blade provided on an outer circumferential surface of a rotating body has a shape with a narrow width in a region adjacent to the rotating body, has a surface widening outwardly, and is formed to be inclined to produce wind.

Due to the nature of the general blower fan, the wind is produced from the outside of the rotating blade, and as the wind is produced from the outside of the rotating blade, the wind produced by the electric fan is blown like a whirlwind, so that the user cannot be evenly exposed to the wind and thus cannot feel coolness. Users tend to use an electric fan by increasing the rotational speed of a blower fan, and when the blower fan is rotated at a high speed, there is a problem in that the power consumption increases.

One of prior arts is Korean Registered Utility Model Publication No. 20-0435430 (published on Jan. 22, 2007) which relates to an electric fan, where a main blade and an auxiliary blade are provided on a rotating body constituting a blower fan that rotates counterclockwise, thereby allowing uniform wind to be generated from the blower fan, and at the same time far-infrared radiation emitted from a far-infrared material coated on a protective net stopper coupled to the front of a protective net is mixed and blown together with the wind.

However, the above prior art has a limitation in that the main blade and the auxiliary blade are integrally formed so that the rotation direction or the rotation speed cannot be controlled differently.

### Technical Problem

The technical problem to be solved by the present invention is to provide a dual blade blower capable of generating various flows of fluid by independently rotating a plurality of blades.

In addition, the present invention is to provide a dual blade blower capable of rotating a plurality of blades in opposite directions to each other using one motor.

Further, the present invention is to provide a dual blade blower capable of blowing air while detecting and flowing a user.

### Technical Solution

A dual blade blower according to an embodiment of the present invention includes a first blade part having a first body formed in an open cylinder shape, and having a plurality of first blades formed on the outer side thereof, a second blade part having a second body, which is formed in an open cylinder shape so as to be inserted into the first body and be freely rotatable, and having a plurality of second blades formed on the inner side thereof, and a bearing which is formed in a circular ring shape so as to be inserted into the first body, and into which the second blade part is inserted.

In addition, the dual blade blower may further include a driving part which rotates the first body or the second body by connecting a belt to an outer peripheral surface of the first body or the second body.

In addition, the dual blade blower may further include a support part having one side coupled to and supporting the first blade part and a central axis connected to a central portion of the second body to support the second blade part.

In addition, when the driving part rotates the first body by connecting the belt to the outer peripheral surface of the first body, the driving part may rotate the second body by connecting a motor to a central portion of the second body.

In addition, the dual blade blower may further include a connecting gear which is connected between the first blade part and the second blade part by gear coupling and interlocks the first blade part and the second blade part to rotate in opposite directions to each other.

### Advantageous Effects

Accordingly, various flows of fluid can be generated by independently rotating the plurality of blades.

In addition, a plurality of blades can be rotated in opposite directions to each other by using one motor.

Further, it is possible to detect a user and blow air while following the user.

### DESCRIPTION OF DRAWINGS

FIG. 1 is a configuration diagram of a dual blade blower according to an embodiment of the present invention.

FIG. 2 is an exploded view of the dual blade blower according to FIG. 1.

FIG. 3 is a configuration diagram in which a connecting gear is added to the dual blade blower according to FIG. 1.

FIG. 4 is an exploded view of the dual blade blower according to FIG. 3.

FIG. 5 is an exemplary view for describing the connection using a bevel gear of a driving part in the dual blade blower according to FIG. 1.

FIG. 6 is a fluid flow diagram for describing the formation of fluid flow in a reverse direction in the dual blade blower according to FIGS. 1 to 5.

FIG. 7 is an exemplary view for describing an example in which an auxiliary blower is added in the dual blade blower according to FIG. 1.

FIG. 8 is an exemplary view for describing an example of following a user through a moving part and a sensing part in the dual blade blower according to FIG. 1.

### MODE FOR INVENTION

Embodiments of the present invention are described below with reference to the accompanying drawings. The terms as used herein are defined in view of functionality as it pertains to the embodiments, but may vary depending on certain practices or intentions of users or operators. Thus, terms that are specifically defined in the specification should be understood with the meaning thus defined, and otherwise, if there is no specific definition for a term, the term should be interpreted according to its common meaning understood by one of ordinary skill in the related art.

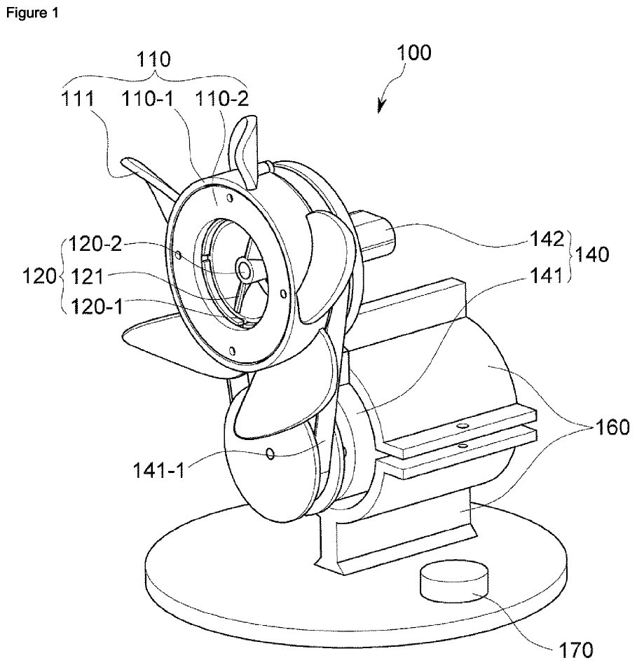

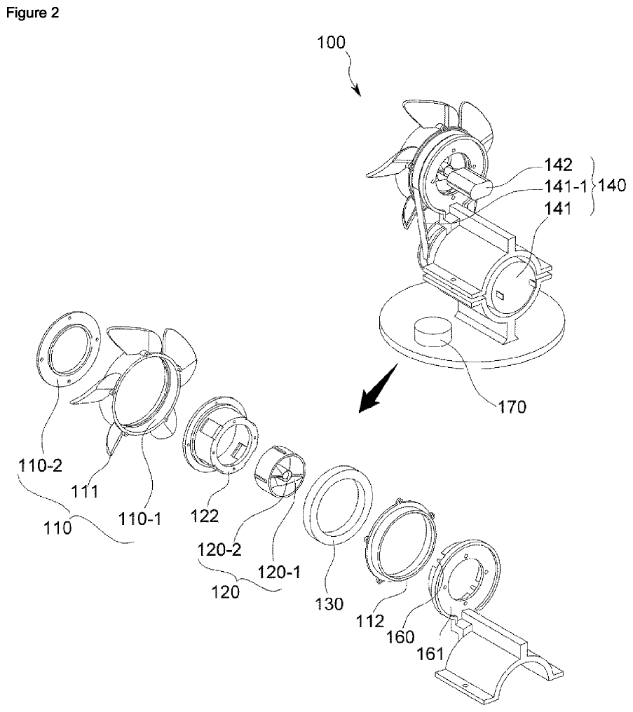

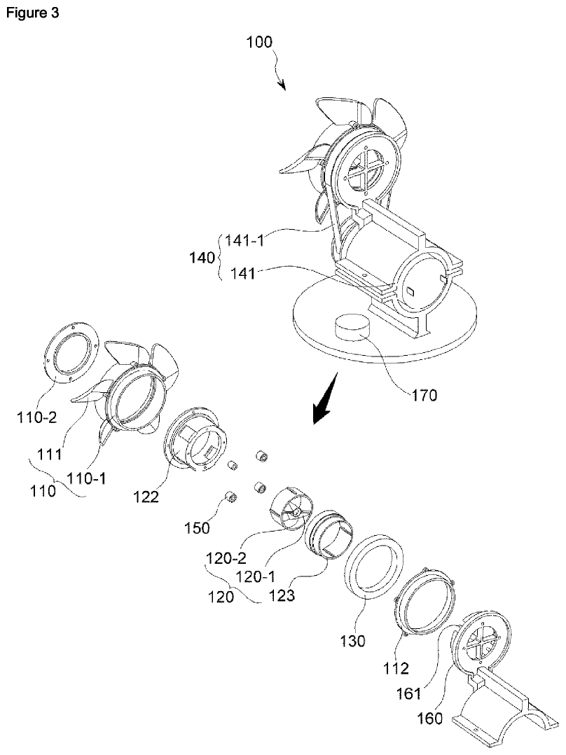

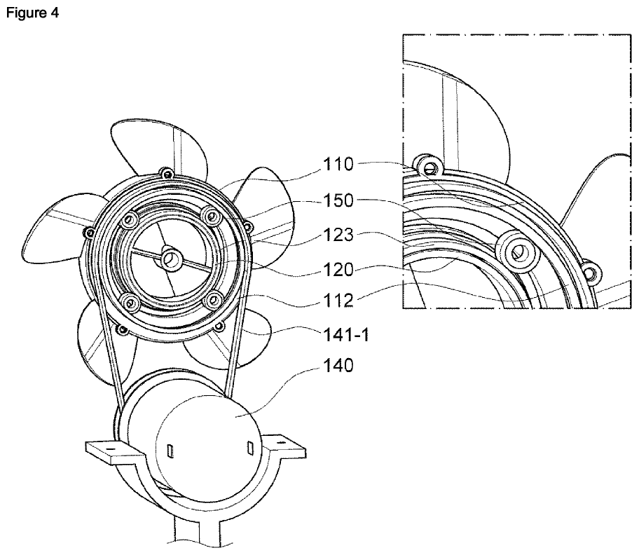

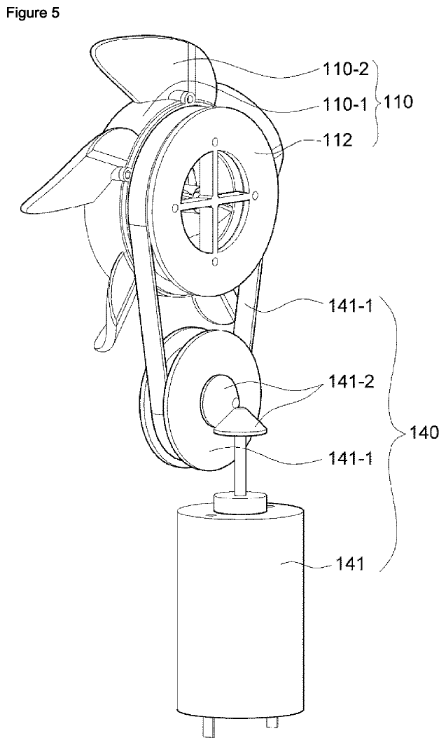

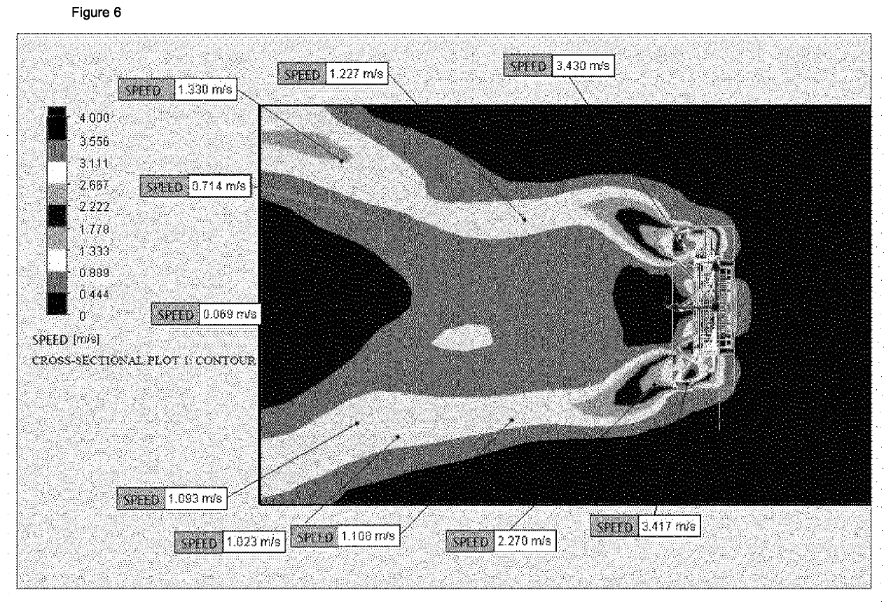

FIG. 1 is a configuration diagram of a dual blade blower according to an embodiment of the present invention, FIG. 2 is an exploded view of the dual blade blower according to FIG. 1, FIG. 3 is a configuration diagram in which a second pulley and a connecting gear area added to the dual blade blower according to FIG. 1, FIG. 4 is an exploded view of the dual blade blower according to FIG. 3, FIG. 5 is an exemplary view for describing the connection using a bevel gear of a driving part in the dual blade blower according to FIG. 1, and FIG. 6 is a fluid flow diagram for describing the formation of fluid flow in a reverse direction in the dual blade blower according to FIGS. 1 to 5.

Referring to FIGS. 1 to 6, the dual blade blower 100 according to an embodiment of the present invention includes a first blade part 110, a second blade part 120, and a bearing 130.

The first blade part 110 has a plurality of first blades 111 formed on an outer side of a first body 110-1 with an open cylindrical shape. The second blade part 120, which will be described below, is accommodated in the first body 110-1 having a cylindrical shape. In this case, a blade cover 110-2 may be formed on one side of the first body 110-1 to prevent the second blade part 120 from escaping off. The shape, size, and number of first blades 111 formed on the outer side of the first blade part 110 may vary according to user settings.

The second blade part 120 may be formed on the inside the first blade part 110 to be spaced apart therefrom. The second blade part 120 is inserted into the first body 110-1 and rotates. The second blade part 120 is formed in an open cylindrical shape. More specifically, the second blade part 120 may have a central portion 120-2 in the center of a second body 120-1 having a cylindrical shape. A plurality of second blades 121 are formed on the inside of the second body 120-1 and rotate. In this case, the shape, size, and number of the second blades 121 may vary according to user settings. This is to variously set flow of fluid produced by the second blades 121.

The bearing 130 is formed in a circular ring shape. The bearing 130 is inserted into the first body 110-1 of the first blade part 110. The second blade part 120 is inserted into the bearing 130. In other words, the first blade part 110 may rotate on the outer side of the bearing 130 and minimize friction thereon. The second blade part 120 may rotate on the inside of the bearing 130 and minimize friction thereon. The size and shape of the bearing 130 may vary depending on the size of the first and second blade parts 110 and 120. Accordingly, the first blade part 110 and the second blade part 120 may freely rotate on the outer side and inside of the bearing 130. Thus, the second blade part 120 may rotate independently of the first blade part 110.

Meanwhile, the dual blade blower 100 according to an embodiment of the present invention may further include a driving part 140.

The driving part 140 includes a first motor 141 configured to rotate the first blade part 110 or the second blade part 120. For example, the first motor 141 may rotate the first blade part 110 or the second blade part 120 using a belt 141-1. In this case, a first pulley 112 is coupled to the other side of the first body 110-1 of the first blade part 110. The first pulley 112 is formed in a circular ring shape. The first pulley 112 has one side connected to the first body 110-1 of the first blade part 110 and the other end connected to the driving part 140 which is described below.

For example, the driving part 140 may rotate by connecting an outer peripheral surface of the first pulley 112 and an output side of the first motor 141 with the belt 141-1. The first pulley 112 may turn in a forward or reverse direction. In this case, a friction surface having protrusions and recesses may be formed on the outer peripheral surface of the first pulley 112 to increase the binding force with the belt 141-1. When the first blade part 110 and the first pulley 112 are coupled to each other, the second blade part 120 which is described below is accommodated in an inner space therebetween. In this case, the second blade part 120 may be spaced apart at a predetermined distance so as not to be in contact with the first blade part 110 or the first pulley 112.

Accordingly, the first body 110-1 of the first blade part 110 rotates in conjunction with the first pulley 112, and the first blade part 110 rotates while the first pulley 112 rotates. In this case, the rotation condition of the first blade part 110 is changed according to the length, rotation speed, and rotation direction of the belt 141-1. The first motor 141 may be powered by an external power source or an internal power source.

In addition, the second blade part 120 may be rotated by connecting the belt 141-1 to the output side of the first motor 141 of the driving part 140 and an outer peripheral surface of the second body 120-1 of the second blade part 120. This is to independently rotate only the second blade part 120. In this case, the first motor 141 may be formed in plurality, and may rotate the first blade part 110 and the second blade part 120, respectively. In this case, the plurality of first motors 141 may have different lengths of the belts 141-1 connected to each other, and the rotational speed and rotational direction thereof may vary by user settings. Accordingly, the first blade part 110 and the second blade part 120 may be rotated differently from each other.

In addition, as shown in FIG. 5, the first pulley 112 may be rotated using the right-angled bevel gear 141-2 on the output side of the first motor 141 of the driving unit 140. In this case, male and female gears of the right-angled bevel gear 141-2 may be formed on one side of a third pulley 143 and the output side of the first motor 141, respectively. The first pulley 112 and the third pulley 143 may be connected by the belt 141-1 on the same plane. Accordingly, the first motor 141 may be positioned in a vertical direction.

Also, the driving part 140 may further include a second motor 142. The second motor 142 is driven independently of the first motor 141. An output side of the second motor 142 is connected to the central portion 120-2 of the second blade part 120 and rotates the second blade part 120. The second motor 142 may be powered by an external power source or an internal power source. The rotation speed and rotation direction of the second motor 142 may vary by user settings.

In this case, the second blade part 120 may further include a second blade frame 122. The blade frame 122 is formed in a cylindrical shape with both sides open. A driving shaft of the second motor 142 of the driving part 140 may be inserted and supported in the central portion 120-1 passing through the center of the second blade part 120. The second blade part 120 may rotate independently of the first blade part 110, and may rotate in a forward or reverse direction. Accordingly, the first blade part 110 and the second blade part 120 may be driven at different speeds or rotate in opposite directions to generate various flows of fluid.

Meanwhile, referring to FIGS. 3 and 4, the dual blade blower 100 according to an embodiment of the present invention may further include a connecting gear 150 and a support part 160.

The connecting gear 150 connects the first blade part 110 and the second blade part 120 by gear coupling. Specifically, the connecting part 150 is connected by meshing with first gear teeth formed on an inner surface of the first pulley of the first blade part 110 and second gear teeth formed on an outer surface of the second pulley 123 of the second blade part 120. In other words, the connecting gear 150 serves to connect the first pulley 112 and the second pulley 123 to interlock with each other. At least one connecting gear 150 may be formed to transmit power from the first pulley 112 to the second pulley 123. The connecting gear 150 may transmit power from the first pulley 112 to the second pulley 123 and power from the second pulley 123 to the first pulley 112. The connecting gear 150 also serves to maintain a constant distance between the first pulley 112 and the second pulley 123.

In this case, the second pulley 123 of the second blade part 120 is formed in a cylindrical shape, and the second pulley 123 is positioned inside the first blade part 110 or the first pulley 112 to be spaced apart therefrom. The second blade part 120 is coupled to the inner side of the second pulley 123. For example, an insertion groove may be formed on the inner surface of the second pulley 123, and a protrusion may be formed on the outer surface of the second blade part 120 and fitted into the insertion groove. The second pulley 123 rotates in conjunction with the second blade part 120. The second pulley 123 may be gear-coupled to the first pulley 112 through the connecting gear 150, which will be described below. In this case, the second gear teeth are formed on one side of the outer peripheral surface of the second pulley 123. In addition, the bearing 130 may be positioned between the second pulley 123 or the other side of the outer peripheral surface of the blade frame 122 and the inner surface of the first blade part 110 to reduce friction.

The support part 160 serves to support the first blade part 110 and the second blade part 120 from the bottom surface. The support part 160 may have one side fixing the first body 110-1 and the first pulley 112 and the other side fixing and supporting the first motor 141. A plurality of fixing shafts 161 may be formed on the support part 160, and the fixing shafts 161 may be inserted into and supported by the connecting gear 150. The connecting gear 150 may be exposed to an open side of the blade frame 122. In this case, the second blade part 120 rotates in the reverse direction in conjunction with the rotation of the first blade part 110. In other words, when the first pulley 112 rotates clockwise, the first blade part 110 rotates clockwise in conjunction with the first pulley 112, and the connecting gear 150 is also rotated clockwise by the first pulley 112. The second pulley 123 connected to the connecting gear 150 rotates counterclockwise, and the second blade part 120 also rotates counterclockwise.

Conversely, when the second blade part 120 rotates clockwise, the second pulley 123 also rotates clockwise and the connecting gear 150 connected thereto rotates clockwise as well. However, the first pulley 112 rotates counterclockwise, and the first blade part 110 that interlocks with the first pulley 112 also rotates counterclockwise. In this case, the driving part 140 may operate only with the first motor 141 or the second motor 142. Accordingly, even when the first blade part 110 or the second blade part 120 is selectively rotated, power is transmitted to each other and rotation in the reverse direction is possible, thereby generating various fluid flows.

Meanwhile, the dual blade blower 100 according to an embodiment of the present invention may further include a control part 170.

The control part 170 may vary the rotation direction and rotation speed of the first motor 141 and the second motor 142. The control part 170 may control the driving part 140 and may vary the rotation direction and rotation speed of the first motor 141 and the second motor 142 to be different from each other. For example, when the first motor 141 is rotated in a forward direction, the second motor 142 may be rotated in a reverse direction. In this case, the first blade part 110 and the second blade part 120 may produce various flows of fluid while rotating in opposite directions. FIG. 6 shows a hydrodynamic flow that appears when the first blade part 110 and the second blade part 120 rotate in opposite directions.

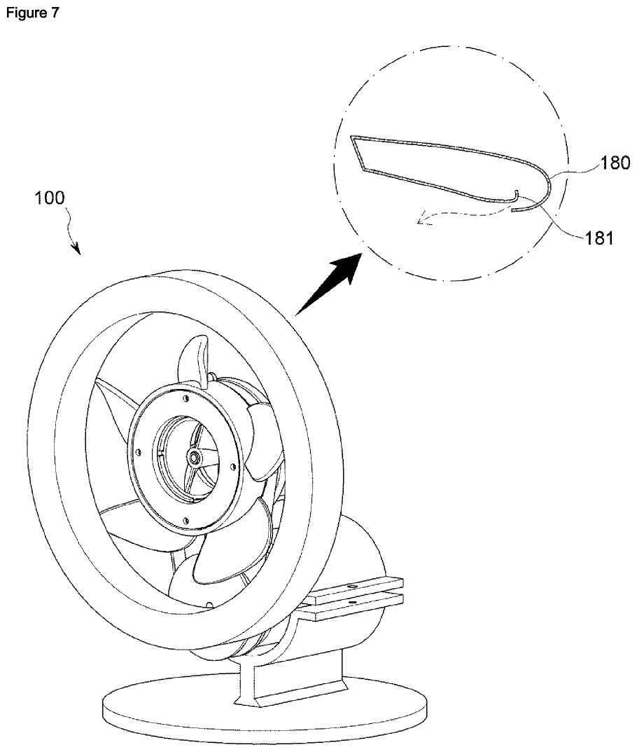

FIG. 7 is an exemplary view for describing an example in which an auxiliary blower is added in the dual blade blower according to FIG. 1.

Referring to FIG. 7, the dual blade blower 100 according to the embodiment of the present invention may further include an auxiliary blower part 180.

The auxiliary blower part 180 is formed in a ring shape on an outer side of the first blade part 110. The ring-shaped auxiliary blower part 180 may have an airfoil shape in cross section. The auxiliary blower part 180 may have a discharge port 181 on one side thereof through which air is discharged. In this case, when air is injected into the auxiliary blower part 180, the air is discharged along the discharge port 181 on one side to induce a pressure difference with the surrounding air. Accordingly, air can be discharged without rotation of the first blade part 110 or the second blade part 120. The control part 170 may operate the first blade part 110 or the second blade part 120 together with the auxiliary blower part 180. In this case, different air supply amounts may be controlled according to the first blade part 110, the second blade part 120, and the auxiliary blower part 180. In addition, a safety net may be formed on an open surface of the auxiliary blower part 180. This is to prevent the user from being injured when the first blade part 110 or the second blade part 120 is rotated.

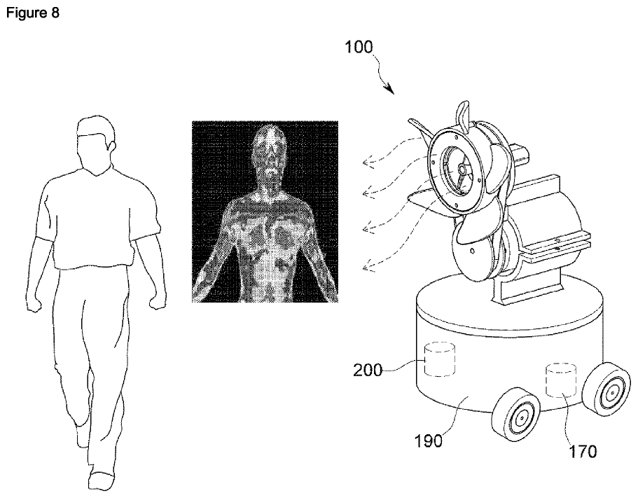

FIG. 8 is an exemplary view for describing an example of following a user through a moving part and a sensing part in the dual blade blower according to FIG. 1.

Referring to FIG. 8, the dual blade blower 100 according to an embodiment of the present invention may further include a moving part 190 and a sensing part 200.

The moving part 190 is driven by wheels using an electric motor. The moving part 190 may be formed in a lower portion of the dual blade blower 100, but is not necessarily limited thereto. The moving part 190 allows for discharging wind while moving in a direction in which the user is moving. In this case, the control part 170 controls the moving speed and moving direction of the moving part 190. The control part 170 may coordinate an indoor position and control the moving part 190 to move. The control part 170 may detect and follow the user's position through communication with a user terminal, but is not necessarily limited thereto.

The sensing part 200 is capable of sensing ambient noise. The sensing part 200 may detect sound from four or more directions around the dual blade blower 100. For example, the sensing part 200 may be formed on each side of the dual blade blower 100 in the east, west, south, and north directions. The sensing part 200 detects sound using an analog sound sensor. The sensing part 200 detects sound from front, rear, left, and right surfaces of the dual blade blower 100, and when a sound of a certain intensity or higher is detected, the sensing part 200 outputs the sound to the control part 170.

In addition, the sensing part 200 may amplify the sound and filter the sound using an envelope which increases a voltage of an output signal by a preset ratio in a first section among successive time sections and reduces the voltage of the output signal in a second section successive to the first section by a preset ratio. This is to amplify the sound when the sound is a user's voice signal and to accurately analyze the voice signal using an envelope optimized for the user's voice.

In this case, the control part 170 sets a movement path in the direction having the maximum value of the intensity of sound by accumulating the intensity of sound in each direction at a preset time period. In this case, the intensity of sound may be set in units of decibels (dB). The control part 170 sets a movement path for moving the dual blade blower 100 forward, backward, left and right. The control part 170 may receive and store the indoor coordinates in advance. This is to set a path to avoid obstacles when moving indoors. The control part 170 accumulates the intensity of the sound in each direction at a constant time period and compares the maximum value.

Also, the control part 170 may determine whether a voice among the sounds from the sensing part 200 is recognized. In this case, when a voice is recognized, the control part 170 extracts a preset command and sets a movement path. In other words, the control part 170 primarily determines whether the sound is a human voice or a machine sound, and secondly determines whether a command is included if the sound is a human voice. This is to distinguish the sound of a television or the like, thereby allowing the dual blade blower 100 to move only when a command instructing the dual blade blower 100 to move is actually expressed. The command for instructing the dual blade blower 100 to move may vary according to user's settings. Accordingly, the dual blade blower 100 may more accurately follow the user by analyzing a human voice command.

In addition, the control part 170 may calculate an angle with respect to a sound source by using a difference between a sound intensity D1 of a first sound sensor positioned in a first direction and a sound intensity D2 of a second sound sensor positioned in a second direction. In this case, a characteristic table indicating a distance according to the sound intensity in each direction is preset. After applying the sound intensity D1 in the first direction and the sound intensity D2 in the second direction to the characteristic table, the same is converted into a distance to determine the position of the sound source by triangulation or the like. The control part 170 may set a movement path by calculating an angle with respect to the sound source from the first direction or the second direction.

Accordingly, it is possible to find the user, or follow the moving user, while moving the dual blade blower 100. This is to allow the dual blade blower 100 to automatically detect the user's position and blow air thereto without requiring the user to manually change the position of the dual blade blower 100.

Also, the sensing part 200 may detect at least one of a user's body temperature, atmospheric temperature, and humidity. For example, the sensing part 200 may detect the user's body temperature using a thermal imaging camera. In this case, the sensing part 200 may detect the body temperature when the user is detected in front by using an illuminance sensor. In addition, the sensing part 200 may detect ambient temperature or humidity using a temperature sensor or a humidity sensor.

In this case, when the control part 170 detects the user around the dual blade blower 100 according to the present invention, the control part 170 may move the dual blade blower 100 to approach a predetermined distance or may control the air blowing strength or air blowing direction by detecting a distance to the user. The control part 170 may detect the user's body temperature at a preset time period and, when the user's temperature reaches a preset temperature range, may change the air blowing strength or stop blowing air. Accordingly, it is possible to actively adjust the air blowing strength or air blowing direction according to the user's body temperature.

Although the present invention has been described on the basis of the embodiments described with reference to the drawings, it is not limited thereto. Therefore, the present invention should be construed on the basis of claims intended for including modifications that can be achieved apparently from the embodiments.

1. A dual blade blower comprising:
a first blade part having a first body formed in an open cylinder shape, and having a plurality of first blades formed on the outer side thereof;
a second blade part having a second body, which is formed in an open cylinder shape so as to be inserted into the first body and be freely rotatable, and having a plurality of second blades formed on the inner side thereof; and
a bearing which is formed in a circular ring shape so as to be inserted into the first body, and into which the second blade part is inserted.

2. The dual blade blower of claim 1, further comprising a driving part which rotates the first body or the second body by connecting a belt to an outer peripheral surface of the first body or the second body.

3. The dual blade blower of claim 1, further comprising a support part having one side coupled to and supporting the first blade part and a central axis connected to a central portion of the second body to support the second blade part.

4. The dual blade blower of claim 2, wherein, when the driving part rotates the first body by connecting the belt to the outer peripheral surface of the first body, the driving part rotates the second body by connecting a motor to a central portion of the second body.

5. The dual blade blower of claim 1, further comprising a connecting gear which is connected between the first blade part and the second blade part by gear coupling and interlocks the first blade part and the second blade part to rotate in opposite directions to each other.
